(19) United States
(12) Patent Application Publication
(10) Pub. No.: US 2023/0142718 A1
(43) Pub. Date: May 11, 2023

(54) SYSTEMS AND METHODS FOR GENERATING DYNAMIC FEED OF EDUCATIONAL CONTENT

(71) Applicant: Pencil Learning Technologies, Inc., Palo Alto, CA (US)

(72) Inventors: Amogh Asgekar, Palo Alto, CA (US); Ayush Agarwal, San Francisco, CA (US)

(73) Assignee: Pencil Learning Technologies, Inc., Palo Alto, CA (US)

(21) Appl. No.: 17/523,823

(22) Filed: Nov. 10, 2021

(51) Int. Cl. G06Q 50/20; G06F 16/903

(52) U.S. Cl. CPC G06Q 50/205; G06F 16/90335

(57) ABSTRACT

The present disclosure provides systems and methods for indexing and presenting teaching resources. A system can generate, using a transformer model, a set of embeddings for information resources. The set of embeddings for each of the information resources collectively form an embeddings space comprising a plurality of pivots. The system can store, in a database, identifiers of the information resources in association with the plurality of pivots. The system can generate query embeddings by inputting a set of query terms received from a client device into the transformer model. The system can determine a subset of the information resources based on a distance in the embeddings space between the query embeddings and the plurality of pivots. The system can present, on a display of the client device, the subset of information resources in response to the set of query terms.

### BACKGROUND

Educators use tedious, manual processes to create, format, and present relevant teaching media into sets as part of a lesson plan or in response to student requests. It can be challenging to efficiently create, select, and present content for many different students.

### SUMMARY

Students often utilize traditional sources of educational information, such as conventional search engines, to answer questions or to retrieve information about a topic of interest. Educators are also tasked with providing similarly relevant information to students, and often utilize similar tools and approaches. However, educators and students often rely on familiar tools, teaching materials, or other sources of information to provide answers to questions or to retrieve information relevant to topics of interest. Such familiar sources of content, however, may not provide the most relevant, or best, content to satisfy a student's question or an educator's teaching objectives. Further, such familiar teaching content and conventional searching tools often provide generic teaching media, which often lack diversity of many content sources. Likewise, conventional search engines are often tasked with optimizing results across a single metric of likely engagement, and thus are not optimized to provide the best content to effectuate ideal learning outcomes for students. Thus, it would be advantageous for an educational content system to automatically classify and index teaching media such that it can be easily accessed and provided to best answer a student query or to achieve a requested learning objective.

The systems and methods of this technical solution solve these and other issues by providing techniques to analyze, tag, and present relevant content in response to student questions or requested learning objectives, as well as proactively offering content based on semantic analysis of other materials being utilized. To do so, the systems and methods of this technical solution can analyze content from many external and internal sources, and build a semantic model of content across many different subjects or topics using indexing techniques as described herein. Queries from students, educators, or other users can be similarly analyzed and mapped to the indexed content to retrieve content that achieves ideal learning outcomes. The techniques described herein can further automatically return any related content across a diverse set of media types, while suggesting a ranked list of results based on competing criteria such as topic similarity, user profiles, or engagement metrics, among others. For example, results may be ranked in some implementations based on student history or a teacher's past preferences or selections, allowing for the system to automatically optimize result selection over time.

At least one aspect of the present disclosure is directed to a method of indexing and presenting teaching resources. The method can be performed, for example, by one or more processors coupled to memory. The method can include generating, using a transformer model, a set of embeddings for each of a plurality of information resources. The set of embeddings for each of the plurality of information resources can be generated such that they collectively form an embeddings space comprising a plurality of pivots. The method can include storing, in a database, identifiers of one or more of the plurality of information resources in association with a corresponding one of the plurality of pivots. The method can include generating query embeddings by inputting a set of query terms received from a client device into the transformer model. The method can include selecting a subset of the plurality of information resources based on a distance in the embeddings space between the query embeddings and the plurality of pivots. The method can include presenting, on a display of the client device, each of the subset of the plurality of information resources in response to the set of query terms.

In some implementations, the method can include receiving, from a second client computing device, a request to update the embeddings database, an identifier of a source of the plurality of information resources. In some implementations, the method can include retrieving the plurality of information resources by accessing the source of the plurality of information resources based on the identifier. In some implementations, generating the set of embeddings can include extracting, from each of the plurality of information resources, textual content comprising one or more tokens. In some implementations, generating the set of embeddings can include providing, for the textual content of each of the plurality of information resources, the one or more tokens as input to the transformer model, causing the transformer model to generate the set of embeddings.

In some implementations, generating the set of embeddings for each of the plurality of information resources can include determining that the plurality of information resources comprises a video information resource. In some implementations, generating the set of embeddings for each of the plurality of information resources can include extracting, responsive to determining that the plurality of information resources comprises the video information resource, a closed-captioning of the video information resource as the textual content comprising the one or more tokens. In some implementations, the method can include selecting the plurality of pivots in the embeddings space based on a clustering technique applied to the plurality of information resources.

In some implementations, selecting the plurality of pivots can include generating a plurality of clusters in the embeddings space from the set of embeddings using the clustering technique. In some implementations, selecting the plurality of pivots can include selecting coordinates in the embeddings space that represent a center of each of the plurality of clusters as the plurality of pivots. In some implementations, selecting the subset of the plurality of information resources can include identifying a predetermined number of the plurality of pivots that are proximate to the query embeddings in the embeddings space. In some implementations, selecting the subset of the plurality of information resources can include selecting the subset of the plurality of information resources having identifiers stored in association with each of the predetermined number of the plurality of pivots.

In some implementations, selecting the subset of the plurality of information resources can include ranking information resources associated with the predetermined number of the plurality of pivots based on at least one of a client device profile associated with the client device, a likelihood of interaction with the information resources, or a categorical relevance of the information resources to the set of query terms. In some implementations, selecting the subset of the plurality of information resources can include selecting the subset of the plurality of information resources based on the ranking of the information resources associated with the predetermined number of the plurality of pivots. In some implementations, ranking the information resources can include a resource format of the information resources associated with the predetermined number of the plurality of pivots. In some implementations, the method can include generating a graphical interface including each of the subset of the plurality of information resources based on a set of formatting rules.

At least one other aspect of the present disclosure is directed to a system for indexing and presenting teaching resources. The system can include one or more processors coupled to memory. The system can generate, using a transformer model, a set of embeddings for each of a plurality of information resources. The set of embeddings for each of the plurality of information resources can be generated such that they collectively form an embeddings space comprising a plurality of pivots. The system can store, in a database, identifiers of one or more of the plurality of information resources in association with a corresponding one of the plurality of pivots. The system can generate query embeddings by inputting a set of query terms received from a client device into the transformer model. The system can select a subset of the plurality of information resources based on a distance in the embeddings space between the query embeddings and the plurality of pivots. The system can present, on a display of the client device, each of the subset of the plurality of information resources in response to the set of query terms. In some implementations, queries may not be explicit (e.g. a user request for information) but may be implicit through additional content being accessed by a user. For example, an agent on a client device may automatically generate and transmit one or more queries based on the content of a web page or other document being accessed or displayed by the client device, and the system may proactively provide suggested information resources to the client device. Accordingly, as used herein, queries may be generated by a user, by a client agent, or both.

In some implementations, the system can receive, from a second client computing device, a request to update the embeddings database, an identifier of a source of the plurality of information resources. In some implementations, the system can retrieve the plurality of information resources by accessing the source of the plurality of information resources based on the identifier. In some implementations, the system can generate the set of embeddings by extracting, from each of the plurality of information resources, textual content comprising one or more tokens. In some implementations, the system can generate the set of embeddings by providing, for the textual content of each of the plurality of information resources, the one or more tokens as input to the transformer model, causing the transformer model to generate the set of embeddings.

In some implementations, the system can generate the set of embeddings for each of the plurality of information resources by determining that the plurality of information resources comprises a video information resource. In some implementations, the system can generate the set of embeddings for each of the plurality of information resources by extracting, responsive to determining that the plurality of information resources comprises the video information resource, a closed-captioning of the video information resource as the textual content comprising the one or more tokens. In some implementations, the system can select the plurality of pivots in the embeddings space based on a clustering technique applied to the plurality of information resources. In other implementations, similar information may be extracted from an audio information resource (e.g. a transcript, or output of a speech-to-text translation engine).

In some implementations, the system can select the plurality of pivots by generating a plurality of clusters in the embeddings space from the set of embeddings using the clustering technique. In some implementations, the system can select the plurality of pivots by selecting coordinates in the embeddings space that represent a center of each of the plurality of clusters as the plurality of pivots. In some implementations, the system can select the subset of the plurality of information resources by identifying a predetermined number of the plurality of pivots that are proximate to the query embeddings in the embeddings space. In some implementations, the system can select the subset of the plurality of information resources by selecting the subset of the plurality of information resources having identifiers stored in association with each of the predetermined number of the plurality of pivots.

In some implementations, the system can select the subset of the plurality of information resources further by ranking information resources associated with the predetermined number of the plurality of pivots based on at least one of a client device profile associated with the client device, a likelihood of interaction with the information resources, or a categorical relevance of the information resources to the set of query terms. In some implementations, the system can select the subset of the plurality of information resources further by selecting the subset of the plurality of information resources based on the ranking of the information resources associated with the predetermined number of the plurality of pivots. In some implementations, the system can rank the information resources further based on a resource format of the information resources associated with the predetermined number of the plurality of pivots. In some implementations, the system can generate a graphical interface including each of the subset of the plurality of information resources based on a set of formatting rules.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. Aspects can be combined and it will be readily appreciated that features described in the context of one aspect of the invention can be combined with other aspects. Aspects can be implemented in any convenient form. For example, by appropriate computer programs, which may be carried on appropriate carrier media (computer readable media), which may be tangible carrier media (e.g. disks) or intangible carrier media (e.g. communications signals). Aspects may also be implemented using suitable apparatus, which may take the form of programmable computers running computer programs arranged to implement the aspect. As used in the specification and in the claims, the singular form of ‘a’, ‘an’, and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1A is a block diagram depicting an embodiment of a network environment comprising a client device in communication with a server device;

FIG. 1B is a block diagram depicting a cloud computing environment comprising a client device in communication with cloud service providers;

FIGS. 1C and 1D are block diagrams depicting embodiments of computing devices useful in connection with the methods and systems described herein;

FIG. 2 is a block diagram of an example system for indexing and presenting teaching resources, in accordance with one or more implementations;

FIG. 3A depicts an example data flow diagram showing the generation of pivots in an embeddings space for information resources, in accordance with one or more implementations;

FIG. 3B depicts an example data flow diagram showing the mapping of embeddings from queries to information resources, in accordance with one or more implementations; and

FIG. 4 illustrates an example flow diagram of a method of indexing and presenting teaching resources, in accordance with one or more implementations.

### DETAILED DESCRIPTION

Below are detailed descriptions of various concepts related to, and implementations of, techniques, approaches, methods, apparatuses, and systems for indexing and presenting teaching resources. The various concepts introduced above and discussed in greater detail below may be implemented in any of numerous ways, as the described concepts are not limited to any particular manner of implementation. Examples of specific implementations and applications are provided primarily for illustrative purposes.

For purposes of reading the description of the various implementations below, the following descriptions of the sections of the Specification and their respective contents may be helpful:

Section A describes a network environment and computing environment which may be useful for practicing embodiments described herein; and

Section B describes systems and methods for indexing and presenting teaching resources.

A. Computing and Network Environment

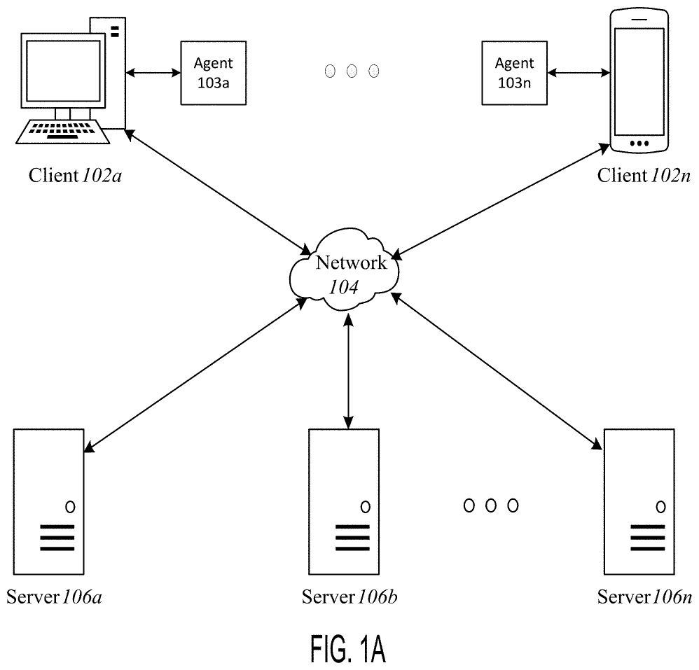

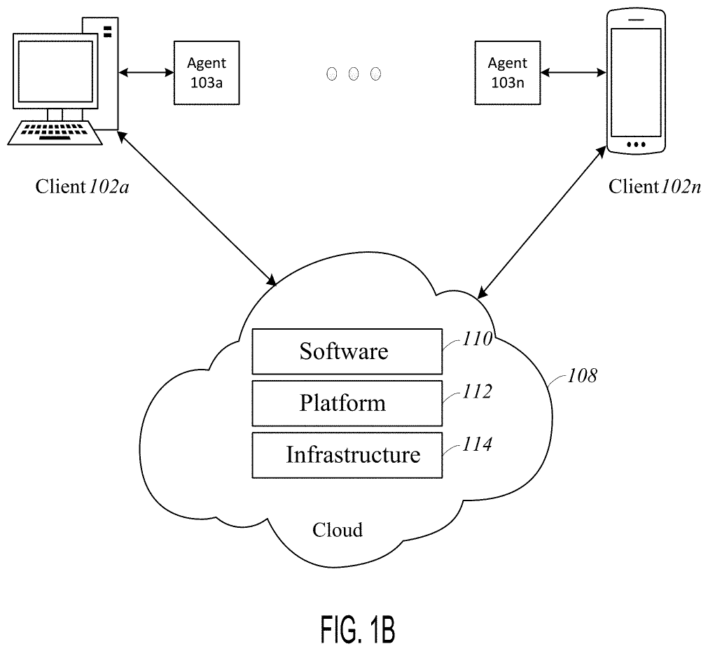

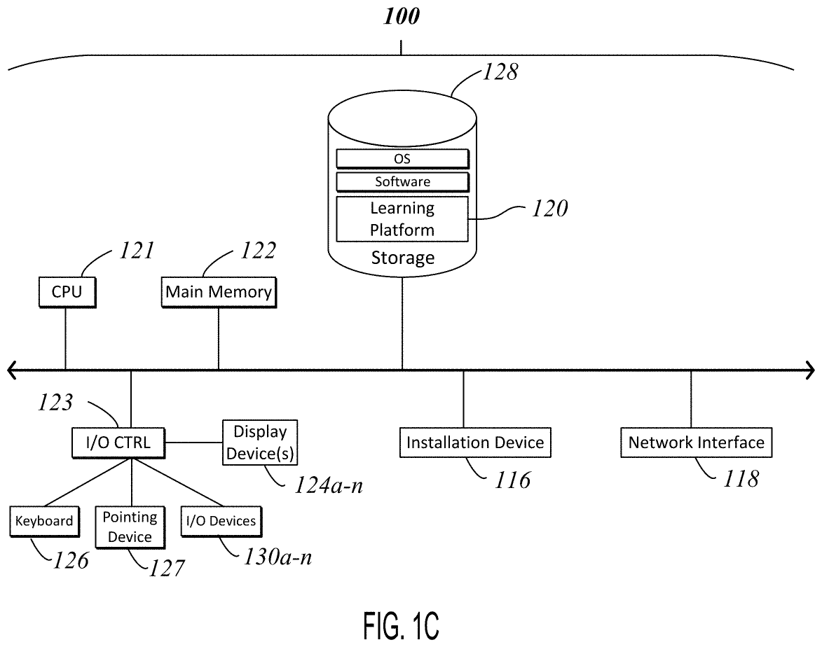

Prior to discussing specific implements of the various aspects of this technical solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more agents 103a-103n and one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 (not shown) or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Washington), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with respective agents 103a-103n and with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, California). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

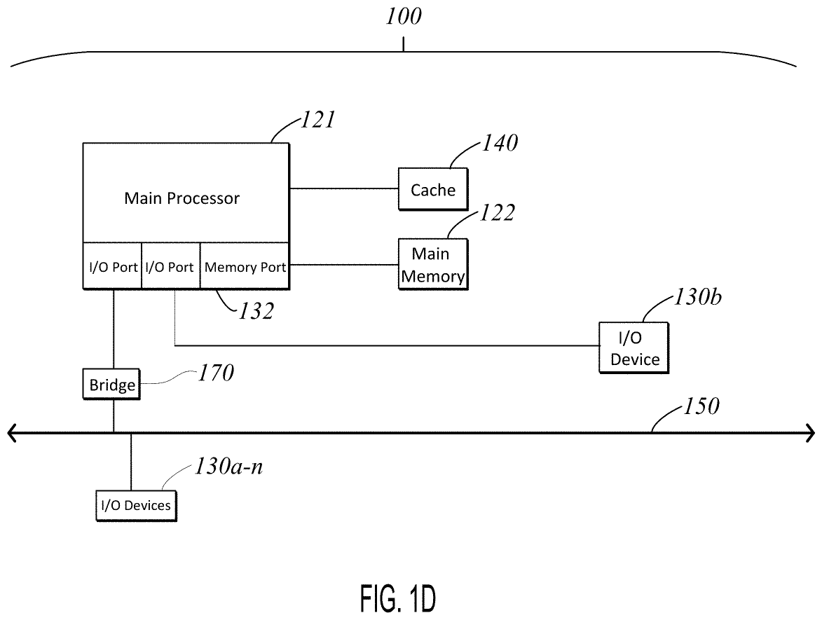

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and learning platform 120, which can implement any of the features of the educational content system 205 described herein below in conjunction with FIG. 2. As shown in FIG. 1D, each computing device 100 may also include additional optional elements, e.g. a memory port 132, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, California; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5, INTEL CORE i7, and INTEL CORE i9.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 132. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopic. Display devices 124a-124n may also be a head-mounted display (HIVID). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the learning platform 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, a PLAYSTATION 4, PLAYSTATION 5, or PLAYSTATION PORTABLE (PSP), or a PLAYSTATION VITA device manufactured by the Sony Corporation of Tokyo, Japan, a NINTENDO DS, NINTENDO 3DS, NINTENDO WII, NINTENDO WII U, or a NINTENDO SWITCH device manufactured by Nintendo Co., Ltd., of Kyoto, Japan, an XBOX 360, an XBOX ONE, an XBOX ONE S, XBOX ONE X, XBOX SERIES S, or an XBOX SERIES X device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is an eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc.; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

B. Indexing and Presenting Teaching Resources

The systems and methods of this technical solution provide techniques for indexing and presenting teaching resources. For example, the techniques described herein include generating relevant related educational content results based on a wide and diverse set of corpora to a given context. In contrast to using key words or terms, the systems and methods described herein analyze an entire item of content (e.g., an information resource, etc.) to generate a semantic understanding of the item of content, regardless of content modality, subject matter, or language.

To do so, the systems and methods of this technical solution can process every type of content differently, such as by using primary data sources and secondary data sources specific to each content type (e.g., text data, image data, video data, etc.) to decipher semantic meaning for educational content. The systems and methods described herein can use the semantically analyzed educational content to measure overall relatedness to other content items, which may have differing subject matter, contextual information, or modalities. For example, while videos presented on an information resource may include descriptions that are manually populated by other providers, and thus potentially misleading or insufficient, the techniques described herein can analyze a closed-caption transcript of the video (e.g., or other aspects of the video, such as performing object detection processes to the frames in the video, etc.) to semantically understand the subject of the video. The semantically analyzed data can then be analyzed in the context of any other additional data presented with the video content, such as a video title or a video description. Although the process described above applies to video content items, it should be understood that other forms of semantic processing can be performed for content having different formats (e.g., image classification and feature detection, audio processing and natural language processing, etc.).

The systems and methods described herein can perform otherwise processor-intensive analysis of content items and content modalities more efficiently than conventional processing techniques. To do so, the systems and methods described herein leverage specialized indexing techniques applied to commodity server databases, which is an improvement over other techniques. Thus, the infrastructure provided by the systems and methods described herein can be efficiently scaled horizontally and vertically using readily available hardware. The indexing techniques described herein thus provide technical improvements to the field of content processing, indexing, and context-based search systems.

In addition to the indexing techniques described herein, the systems and methods of this technical solution can further rank searched educational content across a large set of orthogonal objectives. When returning results in response to a query or request for educational content, the systems and methods described herein can rank content items or information resources across multiple objectives. Consider an example of a math formula returned in response to a request for educational content. In such an example, the systems and methods described herein can assign a ranking to a matched formula which can analyze, among other aspects, whether the returned content is a question or an explanation, whether the content is freely available content or paid content, whether the content includes text, videos, or other modalities, and whether the content is flagged as a review concept or new concepts.

To optimize the ranking across a large number of objectives, the systems and methods described herein leverage augmented neural network models that improve various computing tasks described herein, including computing semantic similarity, computing semantic similarity with self-attention over provided interaction history, and computing an expectation as opposed to a probability. To maximize the ranking of these improved scores, the systems and methods described herein utilize a loss function that optimizes for rank invariance instead of probabilities to provide the most relevant results, including related content.

Additionally, the systems and methods described herein can analyze content that a client device is currently accessing (e.g., via the educational content system described herein, etc.) and incorporate this contextual information into the searching process. Thus, the systems and methods described herein can use the techniques described herein to automatically generate suggestions for useful content based on the current content that is being presented to a user. Further, the techniques described herein can facilitate effective ranking of suggestions for a particular user, according to multiple criteria, and across multiple media types. The systems and methods described herein can provide relevant suggestions agnostic of subject matter, media or language.

Referring now to FIG. 2, illustrated is a block diagram of an example system 200 for indexing and presenting educational content. The system 200 can include at least one educational content system 205, at least one network 210, one or more client devices 220A-220N (sometimes generally referred to as client device(s) 220), and one or more content sources 260A-260N (sometimes generally referred to as provider device(s) 260). The educational content system 205 can include at least one content embeddings generator 225, at least one information resource maintainer 230, at least one query embeddings generator 235, at least one information set selector 240, at least one information resource presenter 245, at least one transformer model 250, and at least one database 215. The database 215 can include one or more information resources 270, one or more content embeddings 275, one or more content requests 280, and contextual data 285. In some implementations, the database 215 can be external to the educational content system 205, for example, as a part of a cloud computing system or an external computing device in communication with the devices (e.g., the educational content system 205, the client devices 220, the content sources 260, etc.) of the system 200 via the network 210.

Each of the components (e.g., the educational content system 205, the network 210, the client devices 220, the content sources 260, the content embeddings generator 225, the information resource maintainer 230, the query embeddings generator 235, the information set selector 240, the information resource presenter 245, the transformer model 250, the database 215, etc.) of the system 200 can be implemented using the hardware components or a combination of software with the hardware components of a computing system, such as the computing system 100 detailed herein in conjunction with FIGS. 1A-1D, or any other computing system described herein. Each of the components of the educational content system 205 can perform any of the functionalities detailed herein.

The educational content system 205 can include at least one processor and a memory, e.g., a processing circuit. The memory can store processor-executable instructions that, when executed by processor, cause the processor to perform one or more of the operations described herein. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The educational content system 205 can include one or more computing devices or servers that can perform various functions as described herein. The educational content system 205 can include any or all of the components and perform any or all of the functions of the computer system 100 described herein in conjunction with FIGS. 1A-1D.

The network 210 can include computer networks such as the Internet, local, wide, metro or other area networks, intranets, satellite networks, other computer networks such as voice or data mobile phone communication networks, and combinations thereof. The educational content system 205 (and the components thereof) of the system 200 can communicate via the network 210, for example, with one or more client devices 220 or with the content sources 260. The network 210 may be any form of computer network that can relay information between the educational content system 205, the one or more client devices 220, and one or more information sources, such as web servers or external databases, amongst others. In some implementations, the network 210 may include the Internet and/or other types of data networks, such as a local area network (LAN), a wide area network (WAN), a cellular network, a satellite network, or other types of data networks. The network 210 may also include any number of computing devices (e.g., computers, servers, routers, network switches, etc.) that are configured to receive and/or transmit data within the network 210. The network 210 may further include any number of hardwired and/or wireless connections. Any or all of the computing devices described herein (e.g., the educational content system 205, the one or more client devices 220, the content sources 260, the computer system 100, etc.) may communicate wirelessly (e.g., via WiFi, cellular, radio, etc.) with a transceiver that is hardwired (e.g., via a fiber optic cable, a CAT5 cable, etc.) to other computing devices in the network 210. Any or all of the computing devices described herein (e.g., the educational content system 205, the one or more client devices 220, the content sources 260, the computer system 100, etc.) may also communicate wirelessly with the computing devices of the network 210 via a proxy device (e.g., a router, network switch, or gateway). In some implementations, the network 210 can be similar to or can include the network 104 or the cloud 108 described herein above in conjunction with FIGS. 1A and 1B.

Each of the client devices 220 can include at least one processor and a memory, e.g., a processing circuit. The memory can store processor-executable instructions that, when executed by processor, cause the processor to perform one or more of the operations described herein. The processor can include a microprocessor, an application-specific integrated circuit (ASIC), a field-programmable gate array (FPGA), etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions can include code from any suitable computer programming language. The client devices 220 can include one or more computing devices or servers that can perform various functions as described herein. The one or more client devices 220 can include any or all of the components and perform any or all of the functions of the computer system 100 described herein in conjunction with FIGS. 1A-1D. The client devices 220 can be, or can be similar to, the client devices 102 described herein above in conjunction with FIGS. 1A-1D.

Each client device 220 can include, but is not limited to, a television device, a mobile device, smart phone, personal computer, a laptop, a gaming device, a kiosk, or any other type of computing device. Each client device 220 can be implemented using hardware or a combination of software and hardware. Each client device 220 can include a display device that can provide visual information, such as information presented as a result of executing instructions stored in the memory of the client device 220, or instructions provided by the educational content system 205 via the network 110, or instructions provided by any other computing device described herein. The display device can include an liquid-crystal display (LCD) device, an organic light-emitting diode (OLED) display, a light-emitting diode (LED) display, a bi-stable display (e.g., e-ink, etc.), amongst others. The display device can present one or more user interfaces on various regions of the display in accordance with the implementations described herein. In some implementations, the display device can include interactive elements, such as a capacitive or resistive touch sensors. Thus, the display device can be an interactive display (e.g., a touchscreen, etc.), and can include one or more input/output (I/O) devices or interfaces.

Each client device 220 can further include or be in communication with (e.g., via a communications bus coupled to the processors of the client devices 220, etc.) one or more input devices, such as a mouse, a keyboard, or digital key pad, among others. The display can be used to present one or more applications as described herein, such as web browsers or native applications. The display can include a border region (e.g., side border, top border, bottom border). The inputs received via the input/output devices (e.g., touchscreen, mouse, keyboard, etc.) can be detected by one or more event listeners (e.g., of an application executing on the client device 220 or of an operating system, etc.), which can indicate interactions with one or more user interface elements presented on the display device of the client devices 220. The interactions can result in interaction data, which can be stored and transmitted by the processing circuitry of the client device 220 to other computing devices, such as those in communication with the client devices 220. The interaction data can include, for example, interaction coordinates, an interaction type (e.g., click, swipe, scroll, tap, etc.), and an indication of an actionable object with which the interaction occurred. Thus, each client device 220 can enable a user to interact with and/or select one or more actionable objects presented as part of graphical user interfaces to carry out various functionalities as described herein.

The client devices 220 can each execute one or more client applications, such as a web browser or a native application that presents educational content provided by the educational content system 205. The one or more client applications can cause the display device of one or more client devices 220 to present a user interface that includes educational content, such as questions, notes, lessons, presentation slides, word documents, online questions, or electronic textbooks, among others. The application can be a web application (e.g., provided by the educational content system 205 via the network 210, etc.), a native application, an operating system resource, or some other form of executable instructions. In some implementations, the client application can include a local application (e.g., local to a client device 220), hosted application, Software as a Service (SaaS) application, virtual application, mobile application, and other forms of content.

In some implementations, the application can include or correspond to applications provided by remote servers or third party servers. In some implementations, the application can access the information resources 270, which can be maintained in the database 215, and generate a user interface that displays one or more of the information resources 270, which can include any content items as described herein, on the display device of the client device 220. In some implementations, an information resource 270 can be a multiple-choice question, and the user interface generated based on the information resource 270 can include one or more actionable objects that correspond to multiple-choice question answers presented as part of the question. In some implementations, an actionable object for an information resource 270 can be a “fill-in-the-blank” box that can accept user input, and transmit the input to the educational content system 205 for storage or further processing. Such actionable objects can include user-selectable hyperlinks, buttons, graphics, videos, images, or other application features that generate a signal that is processed by the application executing on the respective client device 220.

In some implementations, one or more client devices 220 can establish one or more communication sessions with the educational content system 205. The one or more communication systems can each include an application session (e.g., virtual application), an execution session, a desktop session, a hosted desktop session, a terminal services session, a browser session, a remote desktop session, a URL session and/or a remote application session. Each communication session can include encrypted and/or secure sessions, which can include an encrypted file, encrypted data or traffic.

Each of the client devices 220 can be computing devices configured to communicate via the network 210 to access one or the units of the content 270, which can form a part of one or more content sets 290. The units of content 270 can be presented on the client device 220, for example, as part of one or more web pages via a web browser, or application resources via a native application executing on the client device 220. When accessing the units of content 270, the client device 220 can execute instructions (e.g., embedded in the native applications, or a script in a web page displaying the units of content 270, or in the units of content 270 themselves, etc.) that cause the client devices to display educational content, which can include questions, notes, lessons, images, video, audio, quizzes, exams, or other types of educational content. As described herein, the client device 220 can transmit one or more requests for educational content, such as a content request 280 (e.g., which can include a query, etc.), to the educational content system 205, and can receive one or more response messages including ranked lists of relevant information resources 270.

The response messages can include, for example, a list of one or more of the information resources 270 (or identifiers of information resources 270, which may be present on external content servers 270, etc.) that collectively make up a response message. An educational content request can include, for example, one or more queries including one or more keywords. Using a user interface, a user can further specify a topic, a request for a type of information resource (e.g., a question, lesson plan, content format, etc.), a request for a specified information resource 270, or a general request for a lesson plan or introductory subject matter, among others. In some implementations, a client device 220 can login to the educational content system 205 using authentication credentials, such as a username, a password, an authentication key, or another type of authentication technique. The authentication credentials can be associated with a corresponding user profile, which can be associated with performance data for a particular user. In some implementations, upon accessing the educational content system 205 using the authentication credentials, the client device 220 can transmit contextual information 285 to the educational content system 205. The contextual information 285 can be transmitted, for example, with a corresponding content request 280, and thus provide context for the content request 280. The content requests 280 and the contextual information are described in further detail herein below.

The user interfaces provided to the client devices 220 (e.g., in the form of display instructions transmitted by the educational content system 205, etc.) can include one or more actionable objects corresponding to content in the information resources that, when selected, cause the client device 220 to transmit a content request for content that is related to the content identified by the actionable object. The user interface can display one or more portions of the information resources 270, for example by applying one or more templates or display instructions to the information resources 270 such that the information resources 270 are arranged in the user interface. The templates can include formatting rules that specify how content should be formatted (e.g., cascading style-sheets, HTML5, other display instructions, etc.). The user interface can display the information resources 270 in a ranked order. The user interface can include one or more input interfaces (e.g., a search query box, etc.), that can accept a search query relating to one or more topics or categories, difficulty ratings, and an amount of time. Using these search features, a client device can transmit a content request 280 to the educational content system 205 that requests one or more information resources 270 that satisfy the requirements of the query (e.g., the queried topics, difficulty, and time constraints, etc.).

Other information can be transmitted to the educational content system 205. For example, in response to interactions with the various user interface elements displayed in the user interfaces described herein, the client devices 220 can transmit information, such as account information (e.g., changing account parameters, changing login information, etc.), interaction information, selections of question answers, answers to questions, selections of topics, categories, queries for units of content 270 or for one or more content sets 290, or lesson-based information, or other signals to the educational content system 205. This information can be stored by the educational content system 205 in the database 215 as part of the contextual data 285. The contextual data can be stored in association with a user profile that a client device 220 is using to access the functionality of the educational content system 205. Generally, the client devices 220 can request and display educational content received from the educational content system 205. The content requests 280 can include, for example, a request to access one or more information resources 270 relating to a topic or lesson provided by an educator, a request to access an information resource 270 corresponding to a question, a request to access particular information resource 270, or a request for any information related to one or more queries provided by the client devices 220, as described herein. A content request 280 can be a hypertext transfer protocol (HTTP or HTTPS) request message, a file transfer protocol (FTP or FTPS) message, an email message, a text message, or any other type of message that can be transmitted via the network 210. Upon receiving the content request 280, the educational content system 205 can store the content request in association with any contextual data 285 gathered from the transmitting client device 220.

The content sources 260 can each include at least one processor and a memory, e.g., a processing circuit. The memory can store processor-executable instructions that, when executed by the processor, cause the processor to perform one or more of the operations described herein. The processor can include a microprocessor, an application-specific integrated circuit (ASIC), a field-programmable gate array (FPGA), etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions can include code from any suitable computer programming language. The content sources 260 can each include one or more computing devices or servers that can perform various functions as described herein. The content sources 260 can each include any or all of the components and perform any or all of the functions of the computer system 100 described herein in conjunction with FIGS. 1A-1D.

The provider device 260 can be substantially similar to one or more of the client devices 220 described herein above, and can include any of the hardware components of the client devices 220, as well as perform any of the functionalities of the client devices 220 as described herein. In addition, the content sources 260 can each communicate with the educational content system 205 to provide content, which can be stored as one or more of the information resources 270, as described herein. The content sources 260 can be, for example, one or more content platforms that host content or information resources 270 that can be accessed by other computing devices via the network 210. The content can be video content, text content, audio content, web pages, documents, or files, among others. Each of the information resources 270 can be associated with an identifier that can be stored in the database 215 by the educational content system 205. The content sources 260 can receive requests to access any of the content hosted by the content sources 260 from the educational content system 205. In response, the content sources can transmit one or more portions of the information resources 270, which can be stored in the database 215 and processed into respective content embeddings 275. Some examples of content sources 260 can include, for example, video hosting platforms, online encyclopedias, online or electronic textbooks, blogs, government websites, educational websites, electronic books, websites, audio hosting platforms,

The database 215 can be a computer-readable memory that can store or maintain any of the information described herein. The database 215 can maintain one or more data structures, which may contain, index, or otherwise store each of the values, pluralities, sets, variables, vectors, numbers, or thresholds described herein. The database 215 can be accessed using one or more memory addresses, index values, or identifiers of any item, structure, or region maintained in the database 215. The database 215 can be accessed by the components of the educational content system 205, or any other computing device described herein, such as the client devices 220 or the provider device 260, via the network 210. In some implementations, the database 215 can be internal to the educational content system 205. In some implementations, the database 215 can exist external to the educational content system 205, and may be accessed via the network 210. The database 215 can be distributed across many different computer systems or storage elements, and may be accessed via the network 210 or a suitable computer bus interface. The educational content system 205 (or the components thereof) can store, in one or more regions of the memory of the educational content system 205, or in the database 215, the results of any or all computations, determinations, selections, identifications, generations, constructions, or calculations in one or more data structures indexed or identified with appropriate values. Any or all values stored in the database 215 may be accessed by any computing device described herein, such as the educational content system 205, to perform any of the functionalities or functions described herein. In some implementations, the database 215 can be similar to or include the storage 128 described herein above in conjunction with FIG. 1C. In some implementations, instead of being internal to the educational content system 205, the database 215 can be a distributed storage medium in a cloud computing system, such as the cloud 108 detailed herein in connection with FIG. 1B.

The database 215 can store one or more information resources 270, which can be retrieved from the external content sources 270. The information resources 270 can be stored, for example, in one or more data structures in the database 215. In some implementations, one or more of the information resources 270 can be identifiers or references to information resources 270 stored by the content sources 270. The educational content system 270 can store identifiers of the information resources 270, for example, when the information resources are very large (e.g., very long videos, long audio clips, large text information, etc.), or when the content sources 260 do not provide the educational content system 205 with permission to store a particular information resource 270. By providing an identifier of an information resource 270 to a client device, the educational content system 205 can cause the client device 220 to request the information resource from a corresponding content source 260. The information resources can be resources that present specified media content (e.g., specified by instructions in the information resources 280, etc.) in one or more user interfaces. Each information resource 250 can include one or more items of educational content that can be extracted and analyzed by the educational content system 205 to generate corresponding content embeddings 275. The information resources 270 can include, for example, web pages, online quizzes, online exams, practice textbooks, native application pages, word processing documents, packaged document format (PDF) documents, presentation slides, flashcards, videos, audio, electronic textbooks, online encyclopedia entries, or any other type of information presentation medium. The information resources 270 can be accessed by one or more client devices 220, or the educational content system 205. As described herein, the educational content system 205 can access the information resources to extract content and semantically process content in each of the information resources 270.

The information resources 270 can include one or more items of content (sometimes referred to herein as a content item), which can be provided by or retrieved from one or more of the content sources 260. In some implementations, the information resources 270 can include identifiers (e.g., location identifiers such as uniform resource identifiers (URIs), etc.) of content items instructions that cause a computing device accessing (e.g., executing scripts of, displaying, etc.) to retrieve the content items using the identifier. The content items can be retrieved by the accessing computing device (e.g., the client devices 220, the educational content system 205, etc.) from one or more of the content sources 260. The content items can include any form of media, such as questions, quizzes, exams, notes, text, images, video, audio, animated images, or vector drawings, among others. The information resources 270 can each be stored in association with one or more tags, topic identifiers, or category identifiers that indicate the type of information provided by the information resource 270, which include tags, topic identifiers, or category identifiers of each content item included in an information resource. Each content item that is a question (e.g., having the question content type, etc.) can be stored in association with a correct answer to the question, which itself include text information, or other metadata, as described herein. As such, each answer to a question can itself be stored in association with one or more indications of corresponding topic information (e.g., references to topics, subjects, or categories, etc.). The content items can be stored in the database 215 in one or more data structures in association with the information resources 270 including the respective content items.

The information resources 270, or the content items included therein, can have various presentation attributes. For example, images can include presentation attributes such as image height, image width, image format (e.g., BMP, PNG, JPEG, SVG, etc.), image bit-depth, and other image attributes. Presentation attributes for videos can include video duration, video codec, sound codec, and video resolution (e.g., width, height, etc.), closed captioning information (e.g., text content, etc.), among others. Presentation attributes for text can include font type-face, font size, text location, and other information. In some implementations, one or more content items or information resources can include an identifier of a different information resource 270. For example, an information resource 270 can include instructions that cause an identifier (e.g., a hyperlink, a URI, etc.) of another information resource 270 to be presented in a user interface. In some implementations, the presentation attributes of one or more content items or information resources 270 can specify a relative position of content items when presented in the information resource 270. If an information resource 270 includes a question, the information 270 can include content items (e.g., an image, one or more words of text data, one or more segments of video, one or more segments of audio, selectable objects, hyperlinks, radio boxes, etc.) corresponding to one or more answers to the question. For example, if the question is a multiple-choice question, the information resource 270 can include a set of answers made up of one or more content items. The answers can be presented, for example, in on a user interface of a client device 220 accessing the information resource 270, as described herein above.

The database 215 can store one or more content embeddings 275, for example, as part of one or more data structures. The content embeddings 275 can be stored in association with a respective information resource 270. Content embeddings can be generated by the educational content system 205, for example, as output from the transformer model 250. The content embeddings 275 of an information resource 270 can each correspond to an item of semantically analyzed content in the information resource. Said another way, the educational content system 205 can generate a content embedding 275 for each item of content extracted from an information resource 270. Each content embedding 275 can be stored in association with an identifier of the item of content from which the content embedding 275 was generated, and in association with the information resource from which the item of content was analyzed. The embeddings can be an encoded form of text content (e.g., which can be extracted or generated from other types of content, etc.), represented as a real-valued vector. The real-valued vector of a content embedding 275 can encode a “meaning” of a word or term in text content such that words that are closer in the vector space (sometimes referred to herein as the “embeddings space”) are expected to be similar in semantic meaning. As such, while each of the content embeddings 275 may be stored in association with a particular item of content or a particular information source 270, the content embeddings 275 collectively form a single embeddings space (e.g., a real-valued vector space that is independent of any content type, etc.). The content embeddings 275 can be stored in one or more data structures in the database 215, and can be generated, accessed, modified, or deleted by the educational content system 205, as described herein.

The database 215 can store one or more content requests 280, for example, as part of one or more data structures. The content requests 280 can include one or more query keywords, categories, subjects, or other searching information. The content requests 280 can be transmitted by a client device 220. In some implementations, the content requests 280 transmitted by a client device 220 can include contextual data 285 that indicates content (e.g., an information resource including one or more content items, etc.) that the client device 220 is displaying or has recently accessed. The content requests 280 can include, for example, a request to access one or more information resources 270 relating to a topic or lesson provided by an educator, a request to access an information resources 270 corresponding to a question, a request to access particular information resource 270, or a request for any information related to one or more queries provided by the client devices 220, as described herein. A content request 280 can be a hypertext transfer protocol (HTTP or HTTPS) request message, a file transfer protocol (FTP or FTPS) message, an email message, a text message, or any other type of message that can be transmitted via the network 210. In some implementations, the content requests 280 can specify a type of requested content, such as video, audio, text information, or any other type of content. Each content request 280 can be associated with a timestamp that corresponds to the time and date that the content request 280 was transmitted to the educational content system 205. Upon receiving a content request 280 from a client device 220, the educational content system 205 can store the content request 280 as part of one or more data structures in the database 215. In some implementations, a content request 280 can be stored in association with an identifier of the client device 220 that transmitted the content request, or in association an identifier of a profile that the client device 220 used to access the educational content system 205. The educational content system 205 can store content requests 280 in association with any contextual data 285 provided in conjunction with the content request 280.

The database 215 can store contextual data 285, for example, as part of one or more data structures. The contextual data 285 can include information about content or information resources 270 that have been accessed by a client device 220 during or prior to (e.g., within a predetermined time period, etc.) transmission of a content request 270 (e.g., a query or other question). This contextual data 285 can be provided by a client device 220 in one or more messages via the network 210. In some implementations, the contextual data 285 can be transmitted in conjunction with a content request 280. In some implementations, the contextual data 285 can be transmitted on some other basis (e.g., at predetermined time intervals while accessing information resources 270 of the educational content system 205, etc.). The contextual information 285 can include information about the content currently being presented on a client device 220, such as identifiers of information resources 270, textual content presented on the client device 220, identifiers of content presented on the client device 220, identifiers of content or of information resources 270 previously presented on the client device 220 (e.g., within a predetermined time period, during a communication session with the educational content system 205, etc.), or any combination thereof. When received from a client device 220, the educational content system 205 can store the contextual data 285 in association with a timestamp corresponding to the time and date of receipt of the contextual data 285. The contextual data 285 can also be stored in association with an identifier of a client device 220 from which the contextual data 285 was provided, or an identifier of a profile used by the client device 220 to access the educational content system 205. In some implementations, the contextual data 285 can be processed similarly to the information resources 270 described herein to generate one or more contextual embeddings that correspond to content (e.g., items of content or information resources, etc.) specified in the contextual data 285. These contextual embeddings can be mapped to the embeddings space along with embeddings generated from the content requests 280. Each of the components of the educational content system 205 can access, update, or modify the information resources 270, the content embeddings 275, the content requests 280, or the contextual data 285, to carry out functionalities detailed herein.

In some implementations, the database 215 can store one or more profiles (not pictured) corresponding to users that access the educational content system 205 using one or more of the client devices 220. Each of the profiles can be associated with a profile identifier that identifies the profile. In general, the profiles can be accessed via one or more of the client devices 220 using corresponding authentication credentials. For example, a client device 220 can provide the authentication credentials and an identifier of the profile with which a user intends to connect to the educational content system 205 in a login request. A profile can include information about a user, and can be accessed and modified via one or more of the client devices 220. The profiles can identify one or more information resources 270 that have been accessed by one or more client devices 220 while connected to the educational content system 205 using that profile. In some implementations, a profile can be stored in association with one or more corresponding content requests 280 (e.g., requests made using the profile, etc.) and respective contextual data 285, as described herein. In some implementations, a list of previously accessed information resources 270 can be displayed on a display of a client device 220 in response to a request for historical information resource 270 information.

Referring now to the operations of the educational content system 205, the content embeddings generator 225 can generate content embeddings 275 for one or more of the information resources 270. The content embeddings generator 225 can use the transformer model 250 to generate the one or more content embeddings 275 for the information resources. As described herein above, the content embeddings 275 for the one or more information resources can collectively form an embeddings space, which can be an N-dimensional real-valued vector space. By performing a clustering technique on the embeddings space, a number of clusters can be identified. A position (e.g., in the embeddings space, etc.) in the center of each cluster of content embeddings can be considered a pivot, and stored in association with each of the content embeddings 275 in the respective cluster. The pivot can also be stored in association with the information resources 270 that correspond to content embeddings 275 in the cluster.

The content embeddings generator 225 can generate from a number of information resources 270. To do so, the content embeddings generator 225 can access the content sources 260, and request one or more of the information resources hosted by a corresponding content source 260. In some implementations, the content embeddings generator 225 can “scrape” a content source 260, or access each of the information resources hosted by or published by the content sources 260. In such implementations, the content embeddings generator 225 can store identifiers (e.g., names, labels, location identifiers such as URLs or URIs, etc.) of each information resource hosted by the content sources 260 as the information resources 270 in the database 215. In some implementations, the content embeddings generator 225 can receive a request to update the content embeddings 275 stored in the database 215 using content on information resources hosted by a content host 260. The request can include an identifier of a content source 260 that hosts the information resources 270 having the content that is requested to be used to update the content embeddings 275 with additional embeddings, as described herein. Upon identifying the content source 260 from the request, the content embeddings generator 225 can retrieve the information resources 270 by accessing the content source 260 using identifier (e.g., which can be a URL or a URI, etc.). Once the content embeddings generator 225 identifies an information resource 270 to generate content embeddings, the content embeddings generator 225 can access (e.g., download or display, etc.) the information resource and any content identified as forming a part of the information resource 270 (e.g., text content, video content, images, audio content, any information resource metadata or tags, etc.). For each item of content that is not text-based content, the content embeddings generator 225 can generate textual content corresponding to that item of content that best describes the semantic understanding of that item of content.

For example, in the case of video content, the content embeddings generator 225 can perform object detection or recognition to extract names of one or more objects in the video content. In addition, the content embeddings generator 225 can identify and extract any closed-captioning information present in the video as text content. If no closed-captioning information is included with the video, the content embeddings generator 225 can perform a speech recognition technique on one or more audio channels of the video, and extract the output to form text content. Such speech recognition techniques can include, for example, neural network models, hidden Markov models, or other speech recognition techniques. The text produced from the speech recognition model can be stored in association with an identifier of the video content item, and used to generate one or more content embeddings 275 as described herein. Similar techniques can be used for audio content. In the case of image content, the content embeddings generator 225 can perform one or more object detection or image recognition techniques that generate one or more labels for the image content. For example, the content embeddings generator 225 can utilize one or more deep neural networks, convolutional neural network models, or other image classification or object detection techniques to generate labels for any images present in an information resource. The labels can be used to generate one or more content embeddings 275 for the image content, as described herein.

For each information resource 270 identified by the content embeddings generator 225, the content embeddings generator 225 can generate content embeddings 275 for each item of content in each information resource. To generate a content embedding, the content embeddings generator 225 can input the text information associated with each item of content on the information resource into the transformer model 250. The transformer model 250 can be a natural language processing model that can take sequences of text information as input, such as the text information of one or more passages in an information resource, text information from a closed-captioning feed in a video, or other text information. The text information can be broken up, for example, by one or more sentences or other passages (phrases, paragraphs, etc.) for processing by the transformer model 250. The transformer model 250 can be a pure attention-only sequence-to-sequence architecture model. The transformer model 250 can be trained to classify content based on subject, topic, or category, to optimize semantic understanding of textual content for an educational environment.

The transformer 250 can be, for example, a Bidirectional Encoder Representations from Transformer (BERT) model, which can include an input layer and many hidden layers. The transformer model 250 can include one or more encoders, and can take a sequence of words as input (e.g., a sentence, etc.) and generate real-valued vector representation for the sequence that maintains the semantic importance of each word (e.g., a token, etc.) in the sentence in vector form. These vector representations can be stored as the content embeddings 275. Put simply, an embedding, such as the content embeddings 275 described herein, is a numerical model of the input sentence. A content embedding 275 generated by the transformer model 250 can model the semantic importance of a word in a sentence in a numeric format. Because content embeddings 275 are numerical in format, mathematical operations can be performed on the content embeddings 275. The content embeddings generator 225 can generate the content embeddings 275 by inputting the textual content to the transformer model 250, and extracting one or more vectors the hidden layers in the transformer model. In some implementations, the content embeddings generator 225 can generate content embeddings 275 for textual content in multiple languages. For example, if an information resource is offered by a content source 260 in multiple languages, the content embeddings generator 225 can generate content embeddings 275 for each language, and store the each of the content embeddings 275 in association with an identifier of the corresponding information resource 270. The content embeddings generator 225 can repeat this process by generating content embeddings 275 for each of the information resources 270 of the content sources 260.

Once the content embeddings 275 have been generated for each of the information resources 270, the content embeddings generator 225 can perform a clustering technique on all of the content embeddings 275 in the vector space shared by the content embeddings 275 (sometimes referred to herein as an embeddings space). As described herein above, the content embeddings 275 are real-valued vector representations of words that are related by semantic meaning. Thus, the words having a similar semantic meaning are likely to be positioned close to one another in the embeddings space shared by the content embeddings 275. By performing a clustering technique on the content embeddings, clusters of similar topics can be created around a center point, which can be referred to as a pivot. The pivots can be vectors having coordinates in the embeddings space that are selected as the center of a cluster of content embeddings 275.

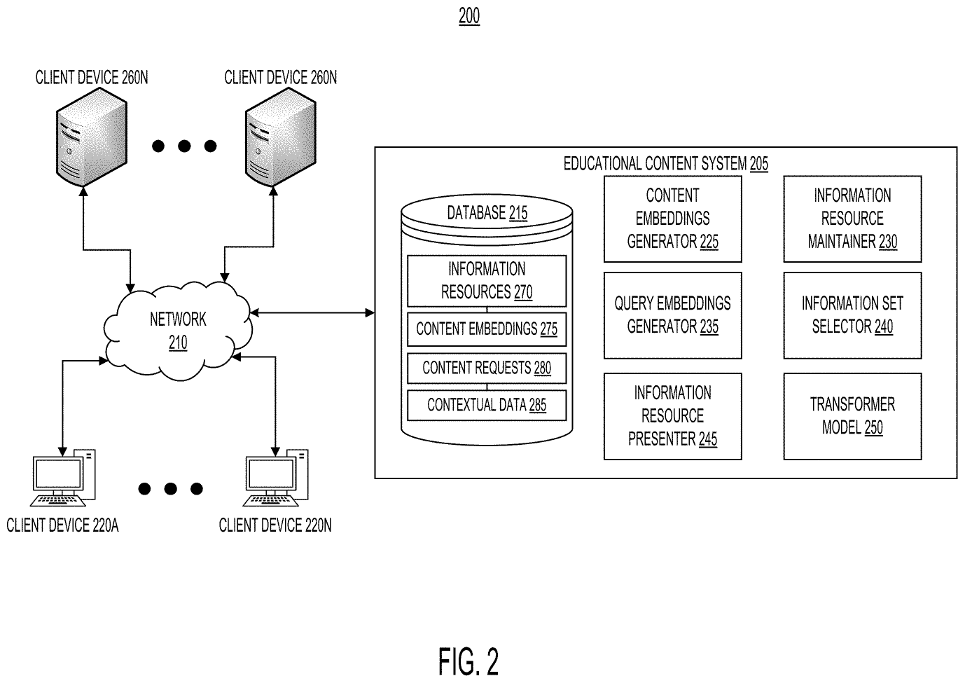

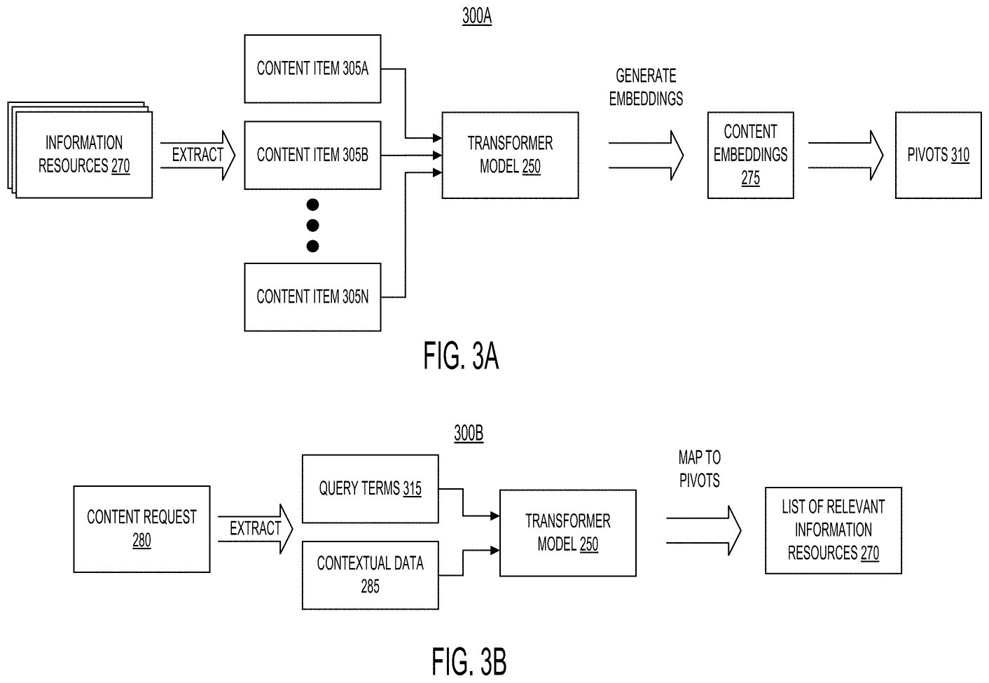

Once the content embeddings generator 225 has generated the content embeddings 275 and selected coordinates in the embeddings space for the pivots, the information resource maintainer 230 can store each of the pivots of each cluster in association with an identifier of each of the information resources 270 corresponding to the embeddings in that cluster. For example, each pivot vector can be stored in association with a list of information resources 270 that each corresponds to a content embedding 275 in the cluster. In some implementations, the list can be an ordered list that is ranked by the proximity (in the embeddings space) of each content embedding 275 to the pivot. For example, an identifier of an information resource 270 corresponding to a content embedding 275 that is close to the pivot in the cluster can be on a higher position in the list of information resources 270 than an identifier of information resource corresponding to a content embedding 275 that is further away from the pivot in the cluster. Thus, the pivots in the embeddings space can represent center points of particular related topics of educational content. Because this semantic understanding of the content is agnostic to language or topic type, the approaches to indexing large numbers of information resources provide more useful representations than other approaches. Further, in the event that additional information resources 270 are identified, the content embeddings 275 generated from those resources can efficiently be clustered such that they are associated with one or more pre-existing pivots. In some implementations, the clustering techniques can be reapplied to the content embeddings 275 after a predetermined number of additional information resources 270 have been analyzed. A dataflow diagram of generating the embeddings space by analyzing information resources 270 is shown in FIG. 3A.

Referring briefly now to FIG. 3A, depicted is an example data flow diagram 300A that shows the generation of pivots in an embeddings space for information resources 270. As shown, content items 305A-305N can be extracted from the information resources 270. Although it is shown that the content items 305A-305N are extracted from the information resources 270 in parallel, it should be understood that other processing arrangements are possible. The content items 305A-305N can include textual content, or can include features or other aspects from which textual content is generated (e.g., closed-captioning information, image classification, object detection, etc.). This textual content is then provided as input to the transformer model 250. Although as shown the content items 305A-305N are each provided as input to the transformer model 250 in parallel, it should be understood that the processing of sentences, words, or other textual content can be adapted to accommodate the input requirements of the transformer model 250. For example, if the transformer model 250 takes one sentence as input at a time, then the textual content of the content items 305A-305N can be analyzed sequentially in accordance with that requirement. The content embeddings 275 can then be extracted from the transformer model 250 as described herein above, and stored in the database 215 in association with the information resource 270 from which the content embedding 275 was generated. A clustering technique can then be used to identify one or more clusters of content embeddings 275, and the pivots 310 can be selected as coordinates in the embeddings space that correspond to the center of each identified cluster.

Referring back now to FIG. 2, the query embeddings generator 235 can generate query embeddings by inputting a set of query terms received from a client device into the transformer model. The query terms can be provided as part of a content request 280. As described herein above, a content request 280 can include one or more words, which can form a question, another type of sentence, phrase, or other text information. Using the transformer model 350, the query embeddings generator 235 can input the text information in the content request 280 to generate query embeddings, similar to the process of generating the content embeddings 275 as described herein above. The content request 280 can be associated with contextual data 285, which can include information about an information resource 270 that is accessed by a client device when the content request 280 was transmitted to the educational content system 205. The contextual data 285 can itself include text data (e.g., such as text displayed on the client device 220, etc.), or can include one or more identifiers of information resources 270 that include text content. The text content from the contextual data 285 (or from the information resources 270 identified in the contextual data 285) can also be provided as input to the transformer model 250 to generate the query embeddings. Because the content embeddings 275 and the query embeddings are generated using the same transformer model 250, the query embeddings and the content embeddings can share the same embeddings space. Thus, the query embeddings can be compared to any vector in the embeddings space, such as the pivots, to determine a distance (e.g., relatedness) of a query embedding to a content embedding 275 (e.g., and thus a corresponding information resource 270, etc.).

Once the query embeddings are generated, the information set selector 240 can select a subset of the information resources 270 that are related to the content request 280 from which the query embeddings were generated. The information set selector 240 can determine related information resources by calculating a distance in the embeddings space between the query embeddings and the plurality of pivots. In some implementations, the information set selector 240 can identify a predetermined number of pivots that are related to the query embeddings in the embeddings space. For example, the information set selector 240 can use the query embeddings in the embedding space to identify the twenty pivots. Recall that each pivot in the embeddings space is stored in association with a list of information resources 270, which each correspond to other content embeddings 275 of the cluster corresponding to the pivot.

The information set selector 240 can select information resources that are associated with relevant pivots to provide in response to the content request 280. For example, in some implementations, the information set selector 240 can select a predetermined number of top ranking (e.g., highest on the list of information resources, closest to the pivot, etc.) information resources 280. In some implementations, the information set selector 240 can rank the information resources 270 associated with each of the identified pivots based on a likelihood of interaction. This likelihood of interaction can be estimated, for example, based on historical interaction data associated with the client device 220 (or the profile being used by the client device 220 that is accessing the educational content system 205. For example, if the historic interaction data in the profile indicates that the user of the profile interacts frequency with information resources having video content items, then the information set selector 240 can sort the information resources 270 in the list of information resources 270 associated with the pivot that include video content to have a higher ranking than information resources 270 in the list not having video content.

In some implementations, the ranking can be further based on a categorical relevance to the content request 280. For example, if the content request 280 specifies one or more category identifiers, the information set selector 240 can sort the information resources 270 in the list of information resources 270 that have category identifier that matches the category identifier in the content request 280 to have a higher ranking than information resources 270 that do not include video content. In some implementations, the information set selector 240 can prioritize certain content formats, or information resources from certain content sources 260. For example, the information set selector 240 can assign a higher rank to information resources 270 that were provided by a predetermined content source 260, or based on a ranking of content sources 260. In some implementations, the information set selector 240 can rank the information resources 270 associated with a pivot based on a type of the information resource 270. For example, if the content request 280 is a question (e.g., a question about a topic, etc.), the information set selector 240 can rank information resources 270 that include explanations (e.g., having an explanation type, etc.) as higher than information resources 270 that are themselves questions.

Although the ranking processes described herein have been described individually, it should be understood that because these are orthogonal aspects, each of these ranking processes can be performed in combination to achieve optimal balancing of these ranking objectives. The information set selector 240 can then select the top ranking information resources from each of the lists of information resources associated with each pivot. In some implementations, the information set selector 240 can combined the lists of information resources associated with each pivot into an aggregate list. The information set selector 240 can then perform one or more of the ranking described herein above on the aggregate list to generate a sorted list of information resources 270 associated with all of the predetermined number of pivots. The information set selector 240 can then select a predetermined number of information resources to provide to the client device 220 from the list. For example, the information set selector 240 can select the top ten information resources from the list. The selected subset of information resource 270 identifiers can then be inserted into one or more messages that can be transmitted to the client device 220 that provided the content request 280. A depiction of an example data flow diagram of the selection of information resources is depicted in FIG. 3B.

Referring briefly now to FIG. 3B, depicted is an example data flow diagram 300B showing the mapping of embeddings from queries to information resources. As shown, the educational content system 205 can receive a content request 280 and extract from the content request 280 any textual data (e.g., query terms, other text data, etc.). In some implementations, a content request 280 can include contextual data 285. The text data from the content request 280 and any text data extracted from the contextual data 285 can be provided as input to the transformer model, in a process that is similar to the generation of the content embeddings 275. The query embeddings can then be mapped to one or more proximate pivots in the embeddings space, as described herein above. For example, as described herein above, a predetermined number of pivots (e.g., the twenty closest, etc.) can be selected as mapping to the query embeddings. The information resources 270 can then be ranked and selected, as described herein above, and used to generate user interface, such as a feed, for the client device 220 that transmitted the content request 280.

Referring back now to FIG. 2, after selecting the subset of information resources 270 in response to the content request 280, the information resource presenter 245 can generate display instructions to display one or more portions of the selected information resources on the client device 220 that provided the content request 280. The display instructions can be in the form of a markup language, such as HTML, XML, or XHTML, among others. The markup language, which can include other scripts such as JavaScript to enhance functionality, can take the form of a “feed”, or a scrollable list of the subset of information resources 270. In some implementations, the feed (e.g., the list of information resources) can be presented in a “pane,” or a portion of another user interface. By using a pane, or a dedicated section of a user interface, the feed can be presented on a client device without obstructing other content being on the client device. This is beneficial for an educational environment—if a student is solving a problem set, or learning about a concept from an electronic textbook, the student can use the client device 220 to transmit queries (e.g., content requests, etc.) related to concepts that are displayed in a main portion of the user interface shown on the client device 220. In response, the information resource presenter 245 can generate display instructions that present the selected subset of information resources 270, such that the information resources 270 are displayed in a non-obstructive pane on a portion of the user interface, that allows a client device to display primary content (e.g., the electronic textbook, etc.) and secondary content (e.g., the information resources in the pane, etc.) without obstructing the primary content. This provides a student with opportunities to supplement primary content with secondary content provided by the educational content system 205, thereby enhancing learning by diversifying teaching media.

The display instructions can include instructions that cause each of the information resources 270 to be displayed in a respective portion. For example, the feed described herein above can be divided into one or more regions, with each region corresponding to an information resource. The information resource presenter 245 can generate markup language (e.g., utilizing and populating one or more templates, etc.) to generate the regions corresponding to each information resource. The templates can include formatting rules that specify how content should be formatted (e.g., cascading style-sheets, HTML5, other display instructions, etc.). Each of the templates can, for example, correspond to a content source 260 or a content format. For example, if a content source 260 is a video hosting platform that hosts videos in a particular content format (e.g., utilizing HTML5 and JavaScript functionality, etc.), the information resource presenter 245 can generate instructions to display information resources 270 in the subset from that content source using a template specific to that content source 260.

In some implementations, if a particular content source can provide content in multiple formats (or in some cases, different modalities such as combinations of text, video, or audio, etc.), the information resource presenter 245 can utilize a template corresponding to the content source 260 and the information resource format(s). The template can include instructions that cause an information resource 270 to be displayed within a region of the information resource feed. By combining the display instructions for each information resource 270 together (e.g., using a composite template to assemble each region in a scrollable feed, etc.), the information resource presenter 245 can generate display instructions to display all of the selected subset of information resources 270 in the feed. The information resource presenter 245 can present the selected information resources 270 in the feed in the ranked order of the information resources 270. Thus, using the techniques described herein above, the educational content system can generate instructions that cause a client device to present a graphical user including portions of each of the subset information resources 270.

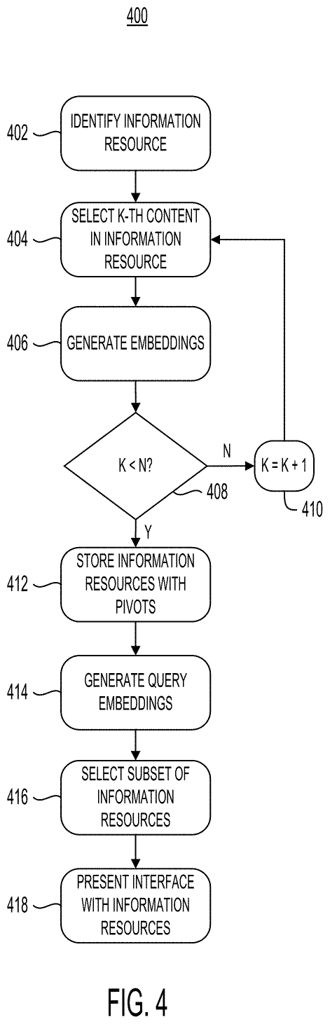

Referring now to FIG. 4, depicted is an example flow diagram of a method 400 of indexing and presenting teaching resources, in accordance with one or more implementations. The method 400 can be executed, performed, or otherwise carried out by the educational content system 205, the computer system 100 described herein in conjunction with FIGS. 1A-1D, or any other computing devices described herein. In brief overview of the method 400, the educational content system (e.g., the education content system 205, etc.) can identify an information resource (e.g., an information resource 270, etc.) (STEP 402), select the k-th content in the information resource (STEP 404), generate content embeddings (e.g., the content embeddings 275, etc.) (STEP 406), determine whether the number of processed content items k is less the number n of content items in the information resource (STEP 408), increment the counter register k (STEP 410), store information resources with pivots (STEP 412), generate query embeddings (STEP 414), select a subset of information resources (STEP 416), and present an interface with information resources (STEP 418).

In further detail of the method 400, the educational content system (e.g., the education content system 205, etc.) can identify an information resource (e.g., an information resource 270, etc.) (STEP 402). The educational content system can access one or more content sources (e.g., one or more of the content sources 260, etc.), and request one or more information resources hosted by a corresponding content source. In some implementations, the educational content system can “scrape” a content source, or access each of the information resources hosted by or published by the content sources. In such implementations, the educational content system can store identifiers (e.g., names, labels, location identifiers such as URLs or URIs, etc.) of each information resource hosted by the content sources in a database (e.g., the database 215, etc.). In some implementations, the educational content system can receive a request to update the content embeddings stored in the database using content on information resources hosted by a content host. The request can include an identifier of a content source that hosts the information resources having the content that is requested to be used to update the content embeddings with additional embeddings, as described herein. Upon identifying the content source from the request, the educational content system can retrieve the information resources by accessing the content source using the content source identifier (e.g., which can be a URL or a URI, etc.). The educational content system can iterate through each of the information resources provided by the content source 260 to perform the operations detailed herein. Once the educational content system identifies an information resources from which to generate content embeddings, the educational content system can access (e.g., download or display, etc.) the information resource and any content identified as forming a part of the information resource (e.g., text content, video content, images, audio content, any information resource metadata or tags, etc.). For each item of content that is not text-based content, the educational content system can generate textual content corresponding to that item of content that best describes the semantic understanding of that item of content.

For example, in the case of video content, the educational content system can perform object detection or recognition to extract names of one or more objects in the video content. In addition, the educational content system can identify and extract any closed-captioning information present in the video as text content. If no closed-captioning information is included with the video, the educational content system can perform a speech recognition technique on one or more audio channels of the video, and extract the output to form text content. Such speech recognition techniques can include, for example, neural network models, hidden Markov models, or other speech recognition techniques. The text produced from the speech recognition model can be stored in association with an identifier of the video content item, and used to generate one or more content embeddings as described herein. Similar techniques can be used for audio content. In the case of image content, the educational content system can perform one or more object detection or image recognition techniques that generate one or more labels for the image content. For example, the educational content system can utilize one or more deep neural networks, convolutional neural network models, or other image classification or object detection techniques to generate labels for any images present in an information resource. The labels can be used to generate one or more content embeddings for the image content, as described herein.

The educational content system can select the k-th content in the information resource (STEP 404). To generate content embeddings for each item of content in an information resource, the education content system can iteratively loop through each item of text content in the information resource based on a counter register k. Each item of text content can be stored and indexed in a data structure by an index value (e.g., index 0, index 1, index 2, etc.). To generate content embeddings for each item of textual content, the educational content system can select the item of textual content (e.g., a sentence, paragraph, etc.) stored in association with an index value equal to the counter register k. If it is the first iteration of the loop, the counter register k may be initialized to an initialization value (e.g. k=0) before selecting the k-th item of text content. Accessing the item of text content can include copying the data associated with the selected text content to a different region of computer memory, for example a working region of memory in the educational content system.

The educational content system can generate content embeddings (e.g., the content embeddings 275, etc.) (STEP 406). To generate a content embedding, the educational content system can input the text information associated with each item of content on the information resource into a transformer model (e.g., the transformer model 250, etc.). The transformer model can be a natural language processing model that can take sequences of text information as input, such as the text information of one or more passages in an information resource, text information from a closed-captioning feed in a video, or other text information. The text information can be broken up, for example, by one or more sentences or other passages (phrases, paragraphs, etc.) for processing by the transformer model. The transformer model can be a pure attention-only sequence-to-sequence architecture model. The transformer model can be trained to classify content based on subject, topic, or category, to optimize semantic understanding of textual content for an educational environment.

The transformer can be, for example, a Bidirectional Encoder Representations from Transformer (BERT) model, which can include an input layer and many hidden layers. The transformer model can include one or more encoders, and can take a sequence of words as input (e.g., a sentence, etc.) and generate real-valued vector representation for the sequence that maintains the semantic importance of each word (e.g., a token, etc.) in the sentence in vector form. These vector representations can be stored as the content embeddings. Put simply, an embedding, such as the content embeddings described herein, is a numerical model of the input sentence. A content embedding generated by the transformer model can model the semantic importance of a word in a sentence in a numeric format. Because content embeddings are numerical in format, mathematical operations can be performed on the content embeddings. The educational content system can generate the content embeddings by inputting the textual content to the transformer model, and extracting one or more vectors the hidden layers in the transformer model. In some implementations, the educational content system can generate content embeddings for textual content in multiple languages. For example, if an information resource is offered by a content source in multiple languages, the educational content system can generate content embeddings for each language, and store the each of the content embeddings in association with an identifier of the corresponding information resource.

The educational content system can determine whether the number of processed content items k is less the number n of content items in the information resource (STEP 408). To determine whether all of the items of content in the information resource(s) have been processed into content embeddings, the educational content system can compare the counter register k used to track the number of processed items of content requested to the number of items of content n. If the counter register k is not equal to (e.g., less than) the total number of items of content n, the educational content system can execute (STEP 410). If the counter register k is equal to (e.g., equal to or greater than) the total number of items of content n, the educational content system can execute (STEP 412).

The educational content system can increment the counter register k (STEP 410). To track the total number of items of content have been processed into content embeddings, the educational content system can add one to the counter register k to indicate the number of items of content have been processed into content embeddings by the educational content system. After incrementing the value of the counter register k, the educational content system can execute (STEP 404).

The educational content system can store information resources with pivots (STEP 412). Once the content embeddings have been generated for each of the information resources, the educational content system can perform a clustering technique on all of the content embeddings in the vector space shared by the content embeddings (sometimes referred to herein as an embeddings space). As described herein above, the content embeddings are real-valued vector representations of words that are related by semantic meaning. Thus, the words having a similar semantic meaning are likely to be positioned close to one another in the embeddings space shared by the content embeddings. By performing a clustering technique on the content embeddings, clusters of similar topics can be created around a center point, which can be referred to as a pivot. The pivots can be vectors having coordinates in the embeddings space that are selected as the center of a cluster of content embeddings.

Once the educational content system has generated the content embeddings and selected coordinates in the embeddings space for the pivots, the educational content system can store each of the pivots of each cluster in association with an identifier of each of the information resources corresponding to the embeddings in that cluster. For example, each pivot vector can be stored in association with a list of information resources that each corresponds to a content embedding in the cluster (e.g., the information resource from which the content embedding was generated, etc.). In some implementations, the list can be an ordered list that is ranked by the proximity (in the embeddings space) of each content embedding to the pivot. For example, an identifier of an information resource corresponding to a content embedding that is close to the pivot in the cluster can be on a higher position in the list of information resources than an identifier of information resource corresponding to a content embedding that is further away from the pivot in the cluster. Thus, the pivots in the embeddings space can represent center points of particular related topics of educational content. Because this semantic understanding of the content is agnostic to language or topic type, the approaches to indexing large numbers of information resources provide more useful representations than other approaches. Further, in the event that additional information resources are identified, the content embeddings generated from those resources can efficiently be clustered such that they are associated with one or more pre-existing pivots. In some implementations, the clustering techniques can be reapplied to the content embeddings after a predetermined number of additional information resources have been analyzed.

The educational content system can generate query embeddings (STEP 414). The educational content system can generate query embeddings by inputting a set of query terms received from a client device into the transformer model. The query terms can be provided as part of a content request. As described herein above, a content request can include one or more words, which can form a question, another type of sentence, phrase, or other text information. Using the transformer model 350, the educational content system can input the text information in the content request to generate query embeddings, similar to the process of generating the content embeddings as described herein above. The content request can be associated with contextual data, which can include information about an information resource that is accessed by a client device when the content request was transmitted to the educational content system. The contextual data can itself include text data (e.g., such as text displayed on the client device, etc.), or can include one or more identifiers of information resources that include text content. The text content from the contextual data (or from the information resources identified in the contextual data) can also be provided as input to the transformer model to generate the query embeddings. Because the content embeddings and the query embeddings are generated using the same transformer model, the query embeddings and the content embeddings can share the same embeddings space. Thus, the query embeddings can be compared to any vector in the embeddings space, such as the pivots, to determine a distance (e.g., relatedness) of a query embedding to a content embedding (e.g., and thus a corresponding information resource, etc.).

The educational content system can select a subset of information resources (STEP 416). The educational content system can select a subset of the information resources that are related to the content request from which the query embeddings were generated. The educational content system can determine related information resources by calculating a distance in the embeddings space between the query embeddings and the plurality of pivots. In some implementations, the educational content system can identify a predetermined number of pivots that are closest to the query embeddings in the embeddings space. For example, the educational content system can use the query embeddings in the embedding space to identify the twenty pivots, which can be related pivots. Recall that each pivot in the embeddings space is stored in association with a list of information resources, which each correspond to other content embeddings in the cluster corresponding to the pivot.

The educational content system can select information resources that are associated with relevant pivots to provide in response to the content request. For example, in some implementations, the educational content system can select a predetermined number of top ranking (e.g., highest on the list of information resources, closest to the pivot, etc.) information resources. In some implementations, the educational content system can rank the information resources associated with each of the identified pivots based on a likelihood of interaction. This likelihood of interaction can be estimated, for example, based on historical interaction data associated with the client device (or the profile being used by the client device that is accessing the educational content system. For example, if the historic interaction data in the profile indicates that the user of the profile interacts frequency with information resources having video content items, then the educational content system can sort the information resources in the list of information resources associated with the pivot that include video content to have a higher ranking than information resources in the list not having video content.

In some implementations, the ranking can be further based on a categorical relevance to the content request. For example, if the content request specifies one or more category identifiers, the educational content system can sort the information resources in the list of information resources that have category identifier that matches the category identifier in the content request to have a higher ranking than information resources that do not include video content. In some implementations, the educational content system can prioritize certain content formats, or information resources from certain content sources. For example, the educational content system can assign a higher rank to information resources that were provided by a predetermined content source, or based on a ranking of content sources. In some implementations, the educational content system can rank the information resources associated with a pivot based on a type of the information resource. For example, if the content request is a question (e.g., a question about a topic, etc.), the educational content system can rank information resources that include explanations (e.g., having an explanation type, etc.) as higher than information resources that are themselves questions.

Although the ranking processes described herein have been described individually, it should be understood that because these are orthogonal aspects, each of these ranking processes can be performed in combination to achieve optimal balancing of these ranking objectives. The educational content system can then select the top ranking information resources from each of the lists of information resources associated with each pivot. In some implementations, the educational content system can combined the lists of information resources associated with each pivot into an aggregate list. The educational content system can then perform one or more of the ranking described herein above on the aggregate list to generate a sorted list of information resources associated with all of the predetermined number of pivots. The educational content system can then select a predetermined number of information resources to provide to the client device from the list. For example, the educational content system can select the top ten information resources from the list. The selected subset of information resource identifiers can then be inserted into one or more messages that can be transmitted to the client device that provided the content request.

The educational content system can present an interface with information resources (STEP 418). The educational content system can generate display instructions to display one or more portions of the selected information resources on the client device that provided the content request. The display instructions can be in the form of a markup language, such as HTML, XML, XHTML. The markup language, which can include other scripts such as JavaScript to enhance functionality, can take the form of a “feed”, or a scrollable list of the subset of information resources. In some implementations, the feed (e.g., the list of information resources) can be presented in a “pane,” or a portion of another user interface. By using a pane, or a dedicated section of a user interface, the feed can be presented on a client device without obstructing other content being on the client device. This is beneficial for an educational environment—if a student is solving a problem set, or learning about a concept from an electronic textbook, the student can use the client device to transmit queries (e.g., content requests, etc.) related to concepts that are displayed in a main portion of the user interface shown on the client device. In response, the educational content system can generate display instructions that present the selected subset of information resources, such that the information resources are displayed in a non-obstructive pane on a portion of the user interface, that allows a client device to display primary content (e.g., the electronic textbook, etc.) and secondary content (e.g., the information resources in the pane, etc.) without obstructing the primary content. This provides a student with opportunities to supplement primary content with secondary content provided by the educational content system, thereby enhancing learning by diversifying teaching media.

The display instructions can include instructions that cause each of the information resources to be displayed in a respective portion. For example, the feed described herein above can be divided into one or more regions, with each region corresponding to an information resource. The educational content system can generate markup language (e.g., utilizing and populating one or more templates, etc.) to generate the regions corresponding to each information resource. The templates can include formatting rules that specify how content should be formatted (e.g., cascading style-sheets, HTML5, other display instructions, etc.). Each of the templates can, for example, correspond to a content source or a content format. For example, if a content source is a video hosting platform that hosts videos in a particular content format (e.g., utilizing HTML5 and JavaScript functionality, etc.), the educational content system can generate instructions to display information resources in the subset from that content source using a template specific to that content source.

In some implementations, if a particular content source can provide content in multiple formats (or in some cases, different modalities such as combinations of text, video, or audio, etc.), the educational content system can utilize a template corresponding to the content source and the information resource format(s). The template can include instructions that cause an information resource to be displayed within a region of the information resource feed. By combining the display instructions for each information resource together (e.g., using a composite template to assemble each region in a scrollable feed, etc.), the educational content system can generate display instructions to display all of the selected subset of information resources in the feed. The educational content system can present the selected information resources in the feed in the ranked order of the information resources. Thus, using the techniques described herein above, the educational content system can generate instructions that cause a client device to present a graphical user including portions of each of the subset information resources.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, e.g., one or more components of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The terms “data processing apparatus”, “data processing system”, “educational content system”, “provider device”, “client device”, “computing platform”, “computing device”, or “device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can include any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as the educational content system 205 can include clients and servers. For example, the educational content system 205 can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML, page) to a client device (e.g., for purposes of displaying data to and receiving input from a user interacting with the client device). Data generated at the client device (e.g., a result of an interaction, computation, or any other event or computation) can be received from the client device at the server, and vice-versa.

The systems and methods discussed herein can also be implemented for mobile use, e.g. on a user's smartphone, smart glasses, tablet computer, or other portable or wearable device. For example, using a camera on such a device, a user may take a picture of a real world entity, such as a painting in a museum. The entity may be recognized (e.g. via a machine learning algorithm, via a reverse image search provided by a search engine service, etc.) and additional educational content may be retrieved for display or further access to the user in a feed or list of information resources. In another implementation, barcodes or other codes may be scanned within an image from a camera of the device (including ISBN codes on books) and information about the corresponding entity may be retrieved (e.g. information about an author, a plot summary, a wikipedia page corresponding to the book, a video review of the book, etc.).

Other sensors may be similarly used, e.g. as initial search parameters or to filter other parameters. For example, a GPS receiver or location service (e.g. WiFi or cellular triangulation or similar methods) of a device may be used to determine a location of the device (and correspondingly the user) and additional information resources may be retrieved based on the location of the device. In some implementations, the location of the device may be used as a search parameter in addition to other data (e.g. from the camera as discussed above). For example, a user may take a picture of a plant and the user's location may be used to narrow down the potential plants that may correspond to the picture based on their native environments, or the location may be used to distinguish between similar search results or information resources that have distinct locations.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the educational content system 205 could be a single module, a logic device having one or more processing modules, one or more servers, or part of a search engine.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. Although the examples provided may be useful for indexing and presenting teaching resources, the systems and methods described herein may be applied to other environments. The foregoing implementations are illustrative rather than limiting of the described systems and methods. The scope of the systems and methods described herein may thus be indicated by the appended claims, rather than the foregoing description, and changes that come within the meaning and range of equivalency of the claims are embraced therein.

What is claimed is:

1. A method of indexing and presenting teaching resources, comprising:
generating, by one or more processors coupled to memory, using a transformer model, a set of embeddings for each of a plurality of information resources, such that the set of embeddings for each of the plurality of information resources collectively form an embeddings space comprising a plurality of pivots;
storing, by the one or more processors, in a database, identifiers of one or more of the plurality of information resources in association with a corresponding one of the plurality of pivots;
generating, by the one or more processors, query embeddings by inputting a set of query terms received from a client device into the transformer model;
selecting, by the one or more processors, a subset of the plurality of information resources based on a distance in the embeddings space between the query embeddings and the plurality of pivots; and
presenting, by the one or more processors, on a display of the client device, each of the subset of the plurality of information resources in response to the set of query terms.

2. The method of claim 1, further comprising:
receiving, by the one or more processors, from a second client computing device, a request to update the embeddings database, an identifier of a source of the plurality of information resources; and
retrieving, by the one or more processors, the plurality of information resources by accessing the source of the plurality of information resources based on the identifier.

3. The method of claim 1, wherein generating the set of embeddings further comprises:
extracting, by the one or more processors, from each of the plurality of information resources, textual content comprising one or more tokens; and
providing, by the one or more processors, for the textual content of each of the plurality of information resources, the one or more tokens as input to the transformer model, causing the transformer model to generate the set of embeddings.

4. The method of claim 3, wherein generating the set of embeddings for each of the plurality of information resources comprises:
determining, by the one or more processors, that the plurality of information resources comprises a video information resource; and
extracting, by the one or more processors, responsive to determining that the plurality of information resources comprises the video information resource, a closed-captioning of the video information resource as the textual content comprising the one or more tokens.

5. The method of claim 1, further comprising selecting, by the one or more processors, the plurality of pivots in the embeddings space based on a clustering technique applied to the plurality of information resources.

6. The method of claim 5, wherein the selecting the plurality of pivots further comprises:
generating, by the one or more processors, a plurality of clusters in the embeddings space from the set of embeddings using the clustering technique; and
selecting, by the one or more processors, coordinates in the embeddings space that represent a center of each of the plurality of clusters as the plurality of pivots.

7. The method of claim 1, wherein selecting the subset of the plurality of information resources comprises:
identifying, by the one or more processors, a predetermined number of the plurality of pivots that are proximate to the query embeddings in the embeddings space; and
selecting, by the one or more processors, the subset of the plurality of information resources having identifiers stored in association with each of the predetermined number of the plurality of pivots.

8. The method of claim 7, wherein selecting the subset of the plurality of information resources further comprises:
ranking, by the one or more processors, information resources associated with the predetermined number of the plurality of pivots based on at least one of a client device profile associated with the client device, a likelihood of interaction with the information resources, or a categorical relevance of the information resources to the set of query terms; and
selecting, by the one or more processors, the subset of the plurality of information resources based on the ranking of the information resources associated with the predetermined number of the plurality of pivots.

9. The method of claim 8, wherein ranking the information resources is further based on a resource format of the information resources associated with the predetermined number of the plurality of pivots.

10. The method of claim 1, further comprising generating, by the one or more processors, a graphical interface including each of the subset of the plurality of information resources based on a set of formatting rules.

11. A system for indexing and presenting teaching resources, comprising:
one or more processors coupled to memory, the one or more processors configured to:
generate, using a transformer model, a set of embeddings for each of a plurality of information resources, such that the set of embeddings for each of the plurality of information resources collectively form an embeddings space comprising a plurality of pivots;
store, in a database, identifiers of one or more of the plurality of information resources in association with a corresponding one of the plurality of pivots;
generate query embeddings by inputting a set of query terms received from a client device into the transformer model;
select a subset of the plurality of information resources based on a distance in the embeddings space between the query embeddings and the plurality of pivots; and
present, on a display of the client device, each of the subset of the plurality of information resources in response to the set of query terms.

12. The system of claim 11, wherein the one or more processors are further configured to:
receive, from a second client computing device, a request to update the embeddings database, an identifier of a source of the plurality of information resources; and
retrieve the plurality of information resources by accessing the source of the plurality of information resources based on the identifier.

13. The system of claim 11, wherein the one or more processors are further configured to generate the set of embeddings by:
extracting, from each of the plurality of information resources, textual content comprising one or more tokens; and
providing, for the textual content of each of the plurality of information resources, the one or more tokens as input to the transformer model, causing the transformer model to generate the set of embeddings.

14. The system of claim 13, wherein the one or more processors are further configured to generate the set of embeddings for each of the plurality of information resources by:
determining that the plurality of information resources comprises a video information resource; and
extracting, responsive to determining that the plurality of information resources comprises the video information resource, a closed-captioning of the video information resource as the textual content comprising the one or more tokens.

15. The system of claim 11, wherein the one or more processors are further configured to select the plurality of pivots in the embeddings space based on a clustering technique applied to the plurality of information resources.

16. The system of claim 15, wherein the one or more processors are further configured to select the plurality of pivots by:
generating a plurality of clusters in the embeddings space from the set of embeddings using the clustering technique; and
selecting coordinates in the embeddings space that represent a center of each of the plurality of clusters as the plurality of pivots.

17. The system of claim 11, wherein the one or more processors are further configured to select the subset of the plurality of information resources by:
identifying a predetermined number of the plurality of pivots that are proximate to the query embeddings in the embeddings space; and
selecting the subset of the plurality of information resources having identifiers stored in association with each of the predetermined number of the plurality of pivots.

18. The system of claim 17, wherein the one or more processors are further configured to select the subset of the plurality of information resources further by:
ranking information resources associated with the predetermined number of the plurality of pivots based on at least one of a client device profile associated with the client device, a likelihood of interaction with the information resources, or a categorical relevance of the information resources to the set of query terms; and
selecting the subset of the plurality of information resources based on the ranking of the information resources associated with the predetermined number of the plurality of pivots.

19. The system of claim 18, wherein the one or more processors are further configured to rank the information resources further based on a resource format of the information resources associated with the predetermined number of the plurality of pivots.

20. The system of claim 11, wherein the one or more processors are further configured to generate a graphical interface including each of the subset of the plurality of information resources based on a set of formatting rules.
